(19) United States
(12) Patent Application Publication
(10) Pub. No.: US 2004/0235696 A1
(43) Pub. Date: Nov. 25, 2004

(54) Emulsion to preserve keen edge of a utensil

(76) Inventor: Ariel S. Pfeffer-Slobodinsky, Sao Paulo (BR)

Correspondence Address: WINSTON & STRAWN, PATENT DEPARTMENT, 1400 L STREET, N.W., WASHINGTON, DC, 20005-3502, US

(21) Appl. No.: 10/824,375

(22) Filed: Apr. 15, 2004

Related U.S. Application Data
(63) Continuation-in-part of application No. 10/444,739, filed on May 23, 2003.

(51) Int. Cl. C11D 1/00

(52) U.S. Cl. 510/218

(57) ABSTRACT

A method and emulsion for preserving the cutting edge of a metal utensil, such as cutlery, surgical tools, and shave blades. The method includes immersing the utensil in the emulsion of the invention, and leaving it immersed for the time in-between use of the utensil. The emulsion includes a water-soluble salt of an ether compound or a chloride compound or both in an amount sufficient to preserve the cutting edge of a utensil, a hydrophobic substance in an amount sufficient to reduce water contact with the edge of the utensil, and an alcohol in an amount sufficient to assist in solubilizing the hydrophobic substance. Immersion of the utensil in the emulsion preserves the sharpness of the cutting edge to facilitate longer service of the utensil.

### CROSS-REFERENCE TO RELATED APPLICATIONS

This application is a continuation-in-part of co-pending U.S. patent application Ser. No. 10/444,739, filed May 23, 2003, the content of which are expressly incorporated herein by reference thereto.

### FIELD OF INVENTION

The present invention relates to an emulsion that preserves the cutting edge of metal utensils. In particular, the emulsion preserves the keen cutting edge for utensils such as cutlery, razor blades, and surgical scalpels and the like. The invention also relates to a method for prolonging the life of a cutting utensil.

### BACKGROUND OF THE INVENTION

Tool steel are utensils that are used in cutting, shaping and sharpening operations. Tool steels are generally characterized by their high level of hardness and resistance to abrasion. Generally, tool steels are known to have good tenacity and other properties such as mechanical resistance at high temperatures. The hardness and abrasion resistance qualities of tools steels are typically obtained by adding high amounts of carbon and alloys such as tungsten, molybdenum, vanadium, manganese and chromium, during the manufacture of the tool steel. In this regard, most tool steels are forged steels, but others are manufactured by accuracy casting or dust metallurgy. The particular raw material added during the manufacture of the tool steel is determinative of the qualities of the resultant tool. Thus, one can manufacture a tool steel with desired qualities based on the selection of the raw material with desired properties.

There are various categories of tool steels including, but not limited to, high-speed steels, hot work steels, low-alloy steels, molding steels, water-hardenable steels, cold deformation steels and shock resistant steels. These categories are based on the applications and characteristics of the tool steel.

For example, high speed steels are developed for milling applications at high speeds. Generally, there are two classes of high speed steels, molybdenum (Group M) and tungsten (Group T). Both molybdenum and tungsten steels perform similarly, but molybdenum steels have a lower initial cost. High-speed steels include, for example, tools, drills, punching machines, taps to open threads and helicoidal grinders. Some grades of high-speed steels may also be used for certain cold applications such as thread shearing, punches and disk cutting matrixes.

Hot work steels (Group H) are used in applications such as metal punching, shearing and forging operations, which are under high temperature, pressure and abrasion conditions. The Group H steels are divided into three subgroups: chromium (from H10 to H19), tungsten (from H21 to H26), and molybdenum (from H42 and H43). Chromium steels are used in mechanical transformation applications at high temperatures. Tungsten steels are used as mandrels or extrusion matrixes for high temperature applications, as for instance the extrusion of copper alloys, nickel alloys and steel.

Cold deformation steels are limited to applications that do not include repeated or extended heating periods under temperatures ranging from 205 to 260° C. They are divided into three groups: air-hardenable steels (Group A), high carbon and high chromium steels (Group D) and oil-hardenable (Group O). The A-group steels are used as shearing knives, punches, cutting of plates for stamping purposes and trimming matrixes. The D-group steels are used in forging tools, thread rolling, deep stamping, brick moulds, calipers, polishing operations, rollers and knives to cut straps. Finally, the O-group steels are used in matrixes and punches for plate stamping cutting, burring, wire drawing, flanging and forging.

Shock-resistant steels include steels whose main alloy elements are manganese, silicon, chromium, tungsten and molybdenum. Almost all steels of this kind (known as Group S) have a carbon content of approximately 0.5%, which provides them with a combination of high resistance and tenacity, and low or mean abrasion wear resistance. Shock-resistant steels are used in slicers, chisels, counter-riveters, punches, guide drills and other applications requiring high tenacity and shock-resistance.

Low-alloy steels (Group L steels) generally have small quantities of chromium, vanadium, nickel and molybdenum. These low-alloy steels are divided into two subgroups, both of which are oil-hardenable steels. In general, low alloy steels are used in machine components such as shafts, cams, plates, mandrels and lathe clamps.

Molding steels (Group P steels) are almost exclusively used in cast pieces under pressure, or moulds for injection or compressions of plastics. Formed from a chromium and nickel alloy, they have characteristics of low softening resistance at high temperatures.

Water-hardenable steels (Group W) mainly comprise carbon as the main alloy element. Small quantities of chromium are added to increase the hardness capacity and abrasion resistance of the steel. Vanadium is added to maintain a fine granulation and consequently greater tenacity. Water-hardenable steels are used in cold forging tools, coining, relief engraving, wood works, hard metal cutting (male and reamer), cutlery and others requiring wear abrasion resistance.

Shock-resistant steels are used in slicers, chisels, counter-riveters, punches, guide drills and other applications requiring high tenacity and shock-resistance.

As is evident, tool steels are expensive materials as compared with other regular steels, and special care must be taken during manufacture to obtain a tool steel having the qualities and characteristics desired. Thus, it is important and desirable to preserve such utensils. Moreover, whenever the tool steels are worked, i.e., via forging, rolling, spinning, pressing or any other method of physical pressure, the metal becomes excessively rigid. In addition, during working of the tool steel, the metal may develop cracks and fissures when the tolerance limit, or fatigue threshold is exceeded. Thus, the operator working with the metals must continuously anneal the tool steel to regain the tools optimum performance characteristics. During the annealing process, metal hardening may occur when the metal is heated at an optimum temperature and then is quickly cooled. This causes the metal to become excessively rigid. Thus, allowing for the greatest hardness possible. Alternatively, when the metal is heated (annealed) and is left to cool slowly and naturally, the result is flexibility and softness.

At high temperatures, iron and carbon are mixed to form a substance called cementite (Fe₃C). Whenever the steel is slowly cooled, the cementite decomposes in iron and graphite, producing a dark and slightly hard material. On the other hand, whenever the cooling process is carried out too quickly, the cementite does not decompose and continues to exist in the solidified piece, originating a harder and brighter material, called hardened steel. The process whereby the steel is heated at proper temperatures and then quickly cooled is called hardening. It provides steels that are useful for the manufacture of the most different utensils and tools.

Because the regular sharpening process for utensils, such as tool steels, is time consuming, it is desirable to have a chemical emulsion for preserving the cutting edge and therefore the sharpness of the utensils.

One example of utensils having a cutting edge are shaving blades. In particular, shaving blades are fabricated from stainless steel. Generally, the stainless steel is martensitic, or magnetic steel. Martensitic and magnetic steel blades are low chromium and high carbon grade, compared to ferrite steel. Martensitic steel such as AISA 420 is widely used for the manufacture of shaving and depilating blades since it provides for optimum hardness after being tempered, strongly resists abrasion and cleans easily.

Regardless of the type of steel used for manufacturing such razor blades, the cutting edge of the blade dulls after each use. Consequently, a clean-cut shave requires use of a new blade after every couple of uses, or requires that used blades be sharpened after every couple of uses.

Sharpening, stoning, and polishing blades are carried out by high-precision, cylindrical grinders with metric systems. Generally, both sides of the blade are sharpened with a 15° gradient. During the sharpening process, the blade is cooled and lubricated with a vaseline-based solution, a phosphate produce, trichloroethylene, zinc salts and polytetrafluoroethylene. Thus, the sharpening process is time consuming and impractical for the typical shaving blade user.

Thus, a need exists for a method and product for preserving the sharp cutting edge of metal utensils such as steel tools and shaving blades without the recurring need for sharpening and polishing by time consuming, impractical means. Advantageously, the emulsion of the present invention provides users of tool steels and shave blades with a product that addresses these needs.

### SUMMARY OF INVENTION

The purpose and advantages of the present invention will be set forth in and apparent from the description that follows, as well as will be learned by practice of the invention. Additional advantages of the invention will be realized and attained by the methods and systems particularly pointed out in the written description and claims hereof as well as from the appended figures.

It has been surprisingly found that it is possible to preserve the cutting effect of metal utensils, such as tool steels, cutlery, scalpels, shaving blades, and the like, by immersing them in the novel emulsion of the present invention. In a preferred embodiment, the metal utensil is immersed in the novel emulsion during non-use for at least one hour for iron or steel utensils and at least three hours for stainless steel utensils. The novel emulsion of the invention prolongs the life of the metal utensil by exploiting at least one of three functions. First, the emulsion takes advantage of the utensil's shape memory properties to maintain its sharp cutting edge. Second, the emulsion prevents the formation of rust on the utensil during non use periods, and lastly, if present, the emulsion protects the chromic oxide protective film on the utensils. Thus, it is possible to prolong the cutting edge life of the utensil, and prolong its use without the need for time consuming and impractical sharpening processes.

In accordance with the present invention, the emulsion comprises either a water-soluble salt of an ether compound or a chloride compound or both in an amount sufficient to preserve the cutting edge of a utensil, a hydrophobic substance in an amount sufficient to reduce water contact with the cutting edge of the utensil, and an alcohol in an amount sufficient to assist in solubilizing the hydrophobic substance, wherein immersion of the utensil in the emulsion preserves the sharpness of the cutting edge to facilitate longer service of the utensil.

In accordance with the present invention, the utensil is a tool steel such as, for example, cutlery, knives, blades, scalpels, scissors, cutters, dies and the like.

For purpose of example and not limitation, the water-soluble salt of an ether compound or a chloride compound is selected from the group consisting of sodium sulphate lauryl ether and cetyltrimethyl ammonium chlorate or a combination thereof, the hydrophobic substance is selected from the group consisting of soap base, anhydrous lanolin, and liquid glycerin, or any combination thereof, and the alcohol is selected from the group consisting of: triethanolamine, and ketostearylic alcohol, or a combination thereof.

In one embodiment, the emulsion comprises soap base in an amount between about 5-15%, sodium sulphate lauryl ether in an amount between about 3 to 7%; ketostearylic alcohol in an amount between about 2 to 4%; cetyltrimethyl ammonium chlorate is present in an amount between about 2 to 4%; anhydrous lanolin is present in an amount between about 3 to 7%; liquid glycerin in an amount between about 3 to 7%; triethanolamine in an amount between about 0.5% to 1.5% and mineral oil in amount between 0 to 2%.

In accordance with another aspect of the present invention, the emulsion further includes a reagent for reducing the deposition of iron oxide on the utensil. In accordance with a preferred embodiment the reagent is a lubricant such as mineral oil.

The emulsion may also contain additives such as aloe vera glycolic extract; propolis glycolic extract; propylene glycol; methyl parabene; hydrolyzed wheat oil; hydrolyzed soya oil; fragrance; and coloring agent, or any combination thereof.

Also in accordance of the invention is a method for preserving the cutting edge of a utensil, the method comprising the steps of: preparing the emulsion, wherein the emulsion comprises at least one of a water-soluble salt of an ether compound or a chloride compound or both in an amount sufficient to preserve the cutting edge of the utensil; a hydrophobic substance in an amount sufficient to reduce water contact with the tool steel's edge; and an alcohol in an amount sufficient to assist in solubilizing the hydrophobic substance, wherein immersion of the tool steel in the emulsion preserves the sharpness of the cutting edge to facilitate longer service of utensil. The components of the emulsion are mixed and homogenized, and allowed to set for about 24 to 32 hours.

### BRIEF DESCRIPTION OF THE DRAWINGS

FIG. 1 compares the effect of varied concentrations of mineral oil on the percent unsharpening factor.

FIG. 2 illustrates the performance of four emulsion formulations as compared to normal use with iron cutlery utensils.

FIG. 3 illustrates the effectiveness of the emulsion formulations with respect to four types of iron cutlery utensils.

FIG. 4 compares the percent output factor for formulas 1 through 4 with respect to iron cutlery utensils.

FIG. 5 illustrates the performance of four emulsion formulations as compared to normal use with stainless steel utensils.

FIG. 6 illustrates the effectiveness of the emulsion formulations with respect to four types of stainless steel utensils.

FIG. 7 compares the percent output factor for formulas 1 through 4 with respect to stainless steel utensils.

### DETAILED DESCRIPTION OF THE PREFERRED EMBODIMENTS

Reference will now be made in detail to the present preferred embodiments of the invention. The formulation and corresponding method of the invention will be described in conjunction with the detailed description of the preferred embodiments.

To achieve these and other advantages and in accordance with the purpose of the invention, as embodied and broadly described, the invention includes an emulsion for preserving the sharpness of the cutting edge of a utensil.

The cutting edge preserving compound comprises either a water-soluble salt of an ether compound or a chloride compound. A wide variety of water soluble salts of fatty acid ether compounds can be used. Generally, the fatty acid component is of sufficient carbon length to provide detergent or surfactant properties to the compound while the sulfate group acts as a cleaner to remove contaminants and preserve the oxide of the edge.

Another cutting edge preserving compound that can be used alone or in combination with the water-soluble salt of an ether compound, is an alkyl chloride, preferable one having an acidic character, such as ammonium group, and an organic component of a fatty acid type moiety, again for detergent or surfactant properties.

As embodied herein, and in accordance with a preferred embodiment of the invention, the emulsion comprises an alkali salt of a fatty ether such as sodium sulfate lauryl ether, an alkyl chloride, such as cetyltrimethyl ammonium chloride, hydrophobic agents, such as anhydrous lanolin, liquid glycerin or a soap base, and an alcohol such as ketostearylic alcohol. The emulsion may further comprise cosmetic agents such as, aloe vera glycolic extract, propolis glycolic extract, propylene glycol, one or more parabenes, such as methylparabene, propylparabene, hydrolyzed wheat oil, hydrolyzed soya oil, triethanolamine, fragrance, color, non-mineralized and deionized water. The emulsion may also comprise a lubricant for reducing the deposition of iron oxide on the utensil.

In accordance with one embodiment of the invention, the emulsion maintains the protective chromium oxide deposited on the cutting edge of utensil during manufacture. In addition, the emulsion prevents the formation of iron oxide deposited on the utensil. While the blade is immersed in the emulsion, it does not contact oxygen and humidity in the air. Therefore, the onset of rust micro-spots which gradually destruct the chromium oxide of the blade, and which is responsible for dulling the blade's keen edge is avoided. Thus, by preserving the chromium oxide covering and reducing the formation of iron oxide on the cutting edge, the fast wear-and-tear of the utensil's cutting edge after its use is avoided.

Furthermore, the emulsion also exploits the metals' martensitic properties by allowing the metals to recover to their previous molecular arrangement, thereby recovering the cutting edge of the utensil. In a preferred embodiment, the emulsion facilitates the altering of the molecular arrangement from hexahedral to octahedral configuration. The emulsion also maintains the blade at a stable pH level.

The components of the emulsion are mixed and homogenized. Once homogenized, the mix is put aside for 24 to 32 hours, after which, it is ready for immersion of the tool steels. In accordance with a preferred embodiment of the invention, the cutting edge of a metal utensil is preserved by immersing the utensil before and after each use in the emulsion.

The utensils include any tool steel having a keen cutting edge. For example, the utensils include, but are not limited to, knives, cutlery, blades, such as shaving blades, scalpels, scissors, clippers, cutters, manicure tools, surgical tools and the like. Furthermore, the cutting edge of the utensil can be fabricated from any suitable metal used in the art, including but are not limited to stainless steels, iron, steels and various alloys thereof.

In accordance with a preferred embodiment of the invention, the emulsion comprises the following components in wt %:

| | |
|---|---|
| Soap base | from 5 to 15% |
| Sodium sulfate lauryl ether | from 3 to 7% |
| Ketostearylic alcohol | from 2 to 4% |
| Cetyltrimethyl ammonium chloride | from 2 to 4% |
| Anhydrous lanolin | from 3 to 7% |
| Liquid glycerin | from 3 to 7% |
| Aloe vera glycolic extract | from 1 to 3% |
| Propolis glycolic extract | from 1 to 3% |
| Propylene glycol | from 0.3 to 0.7% |
| Methylparaben | from 0.1 to 0.3% |
| Propylparaben | from 0.1 to 0.3% |
| Hydrolyzed Wheat Oil | from 0.3 to 0.7% |
| Hydrolyzed Soya Oil | from 0.3 to 0.7% |
| Triethanolamine | from 0.5 to 1.5% |
| Mineral oil | from 0 to 2% |
| Fragrance (optional) | from 0.3 to 0.7% |
| Color (optional) | about 0.01% |
| Non-mineralized, deionized water | q.s.p. 100% |

In accordance with a further embodiment of the invention, the emulsion comprises:

| | |
|---|---|
| Soap base | from 3 to 7% |
| Sodium sulfate lauryl ether | from 2 to 4% |
| Ketostearylic alcohol | from 1 to 3% |
| Cetyltrimethyl ammonium chloride | from 1 to 3% |
| Anhydrous lanolin | from 3 to 7% |
| Liquid glycerin | from 3 to 7% |
| Aloe vera glycolic extract | from 1 to 3% |
| Propolis glycolic extract | from 1 to 3% |
| Propylene glycol | from 0.3 to 0.7% |
| Methylparaben | from 0.1 to 0.3% |
| Propylparaben | from 0.1 to 0.3% |
| Hydrolyzed Wheat Oil | from 0.15 to 0.35% |
| Hydrolyzed Soya Oil | from 0.15 to 0.35% |
| Triethanolamine | from 0.3 to 0.7% |
| mineral oil | from 0 to 2% |
| Fragrance (optional) | from 0.3 to 0.7% |
| Color (optional) | about 0.01% |
| Non-mineralized, deionized water | q.s.p. 100% |

In yet another embodiment of the invention, the emulsion comprises:

| | |
|---|---|
| Sodium sulfate lauryl ether | from 15 to 25% |
| Aloe vera glycolic extract | from 1 to 3% |
| Propolis glycolic extract | from 1 to 3% |
| Fragrance | from 0.2 to 0.7% |
| Glycerin | from 3 to 7% |
| Triethanolamine | from 1 to 3% |
| Propylene glycol | from 0.3 to 0.7% |
| Methylparabene | from 0.1 to 0.3% |
| Propylparabene | from 0.1 to 0.3% |
| Color | 0.01% |
| Mineral Oil | from 0 to 2% |
| Non-mineralized, deionized water | q.s.p. 100% |

In yet another embodiment of the invention, the emulsion comprises:

| | |
|---|---|
| Cetyltrimethyl ammonium chloride | from 15 to 25% |
| Aloe vera glycolic extract | from 1 to 3% |
| Propolis glycolic extract | from 1 to 3% |
| Fragrance | from 0.3 to 0.7% |
| Glycerin | from 3 to 7% |
| Triethanolamine | from 1 to 3% |
| Propylene glycol | from 0.3 to 0.7% |
| Methylparabene | from 0.1 to 0.3% |
| Propylparabene | from 0.1 to 0.3% |
| Color | 0.01% |
| Mineral Oil | from 0 to 2% |
| Non-mineralized, deionized water | q.s.p. 100% |

In preferred embodiment, the emulsion may comprise any one of the following formulas preferably for use with utensils such as razor blades:

| | Formula | Formula | Formula | Formula |
|---|---|---|---|---|
| | A | B | C | D |
| Soap base | 10% | 5% | | |
| Sodium sulfate lauryl ether | 5% | 3% | 20% | |
| Ketostearylic alcohol | 3% | 2% | | |
| Cetyltrimethyl ammonium | 3% | 2% | | 20% |
| chloride | | | | |
| Anhydrous lanolin | 5% | 5% | | |
| Liquid glycerin | 5% | 5% | 5 | 5% |
| Aloe vera glycolic extract | 2% | 2% | 2 | 2% |
| Propolis glycolic extract | 2% | 2% | 2 | 2% |
| Propylene glycol | 0.5% | 0.5% | 0.5% | 0.5% |
| Methylparaben | 0.2% | 0.2% | 0.2% | 0.2% |
| Propylparaben | 0.2% | 0.2% | 0.2% | 0.2% |
| Hydrolyzed Wheat Oil | 0.5% | 0.25% | | |
| Hydrolyzed Soya Oil | 0.5% | 0.25% | | |
| Triethanolamine | 1% | 0.5% | 2% | 2 |
| Fragrance (optional) | 0.5% | 0.5% | 0.5% | 0.5% |
| Color (optional) | 0.01% | 0.01% | 0.01% | 0.01% |
| Non-mineralized, deionized | q.s.p. | q.s.p | q.s.p | q.s.p. |
| water | 100% | 100% | 100% | |

In yet another embodiment, the emulsion may comprise any one of the following formulations that are preferably used for utensils fabricated from iron or steel type metals, i.e., those that generally form iron oxides on their surface during use or when otherwise exposed to oxygen:

| | Formula | Formula | Formula | Formula |
|---|---|---|---|---|
| | 1 | 2 | 3 | 4 |
| Soap base | 10% | 5% | | |
| Sodium sulfate lauryl ether | 5% | 3% | 20% | |
| Ketostearylic alcohol | 3% | 2% | | |
| Cetyltrimethyl ammonium chloride | 3% | 2% | | 20% |
| Anhydrous lanolin | 5% | 5% | | |
| Liquid glycerin | 5% | 5% | 5% | 5% |
| Propylene glycol | 0.5% | 0.5% | 0.5% | 0.5% |
| Methylparaben | 0.2% | 0.2% | 0.2% | 0.2% |
| Propylparaben | 0.2% | 0.2% | 0.2% | 0.2% |
| Triethanolamine | 0.2% | 0.1% | 1% | 1% |
| Fragrance (optional) | 0.5% | 0.5% | 0.5% | |
| Color (optional) | 0.01% | 0.01% | 0.01% | 0.01% |
| Mineral Oil | 0.5% | 1% | 1% | 1% |
| Non-mineralized, deionized water | q.s.p | q.s.p. | q.s.p. | q.s.p. |
| | 100% | 100% | 100% | 100% |

In yet another embodiment, the emulsion may comprise any one of the following formulas that are preferably used with utensils fabricated from stainless steel of other metals that generally form a chromium containing oxide on their surface during use or when otherwise exposed to oxygen:

| | Formula | Formula | Formula | Formula |
|---|---|---|---|---|
| | 5 | 6 | 7 | 8 |
| Soap base | 10% | 5% | | |
| Sodium sulfate lauryl ether | 5% | 3% | 20% | |
| Ketostearylic alcohol | 3% | 2% | | |
| Cetyltrimethyl ammonium | 3% | 2% | | 20% |
| chloride | | | | |
| Anhydrous lanolin | 5% | 5% | | |
| Liquid glycerin | 5% | 5% | 5% | 5% |
| Propylene glycol | 0.5% | 0.5% | 0.5% | 0.5% |
| Methylparaben | 0.2% | 0.2% | 0.2% | 0.2% |
| Propylparaben | 0.2% | 0.2% | 0.2% | 0.2% |
| Triethanolamine | 0.1% | 0.5% | 2% | 2% |
| Fragrance (optional) | 0.5% | 0.5% | 0.5% | 0.5% |
| Color (optional) | 0.01% | 0.01% | 0.01% | 0.01% |
| Non-mineralized, deionized water | q.s.p | q.s.p. | q.s.p. | q.s.p. |
| | 100% | 100% | 100% | 100% |

The active components of the emulsion that preserve the cutting edge by preserving the chromium oxides are soap base, e.g., salts of fatty acids of animal tallow saponification, sodium sulfate lauryl ether, ketostearylic alcohol, cetyltrimethyl ammonium chloride, glycerin, triethanolamine, and lanolin.

The emulsion may further include a reagent to inhibit the formation of iron oxide on the iron or steel type utensils. For example, the reagent includes lubricants, such as mineral oil to protect against formation of the iron oxide. In a preferred embodiment, the concentration of mineral oil ranges from 0.5 to 3 wt % of the emulsion. In a more preferred embodiment, the concentration of mineral oil ranges form 1 to 2 wt % of the emulsion.

The aloe vera and propolis glycolic components of the formulation are within a hydrophobic and oily medium and remain on the blade after it is removed from the emulsion, and rinsed with water before its use. The propolis and the oily part of the emulsion formulation, i.e., aloe vera and propolis glycolic extracts, are preferably dissolved in cetyltrimethyl ammonium chlorateand eliminate microscopic burrs, which often occur during the manufacture of the utensil's cutting edge, for example in a shaving blade. The burrs are eliminated by the homogenization of the blade within the emulsion. When the utensil, for example the blade, is submerged in the emulsion of the invention, the microscopic burrs are eliminated due to the martensitic property of the blade material. The emulsion excites the molecular regeneration of the blade causing the homogenization For purposes of illustration and not limitation, eliminating the microscopic burrs on the cutting edge of a utensil, such as a blade, minimizes the cuts on the skin of a user's face or body which are generally caused by the microscopic burrs.

In a preferred embodiment, the utensil is immersed in the emulsion of the invention after each use and until its next use. The longer the duration of the immersion of the utensil, the more effective the results. A longer “sit” time in the emulsion imparts better lubrication of the cutting edge, more-thorough cleaning, and greater impermeability to oxygen attack. In accordance with an exemplary embodiment of the invention, the emulsion prevents oxygenation of the metal of the cutting edge by conserving the chromium oxide layer. For example, one advantage from the more-thorough cleaning of the cutting edge of a utensil, for example a blade, is that the likelihood that a user will become irritated from use of the blade is minimized.

The emulsion further includes lubricants such as anhydrous lanolin, liquid glycerin, aloe vera glycolic extract, propolis glycolic extract and propylene glycol, or any combination thereof, for lubricating the surface of the cutting edge. These components as well as the remaining components of the emulsion generally have a cosmetic function and are optional additives although they usually provide benefits to the user. For example, as hair is removed by the keen edge of a sharp shaving blade, the lubricant provided to the blade by the emulsion penetrates into the pores of the skin, making it smooth and soft.

The formulations may be adjusted to account for the various properties of the metal utensils, which include, but are not limited to, material of construction of the cutting edge, the cutting edge thickness, and the protective layer or film present on the cutting edge surface. For example, mineral oil can be added to the formulation to inhibit the formation of iron oxide on utensils fabricated from iron or steel. In addition, for purposes of example and not limitation, sodium sulfate lauryl ether or cetyltrimethyl ammonium chlorateor both may be provided in an amount effective to maintain the protective layer present on the cutting edge surface of stainless steel, such as, for example, the chromium oxide layer.

The reagents of the emulsion are provided in a proper stoichiometric amount such that the emulation is a homogeneous mixture.

In accordance with a preferred embodiment of the invention, a utensil to be preserved is immersed in the solution for at least one hour prior to their first use. Utensils that have already been used must be immersed in the emulsion for at least three hours before use. The emulsion of the present invention will extend the duration of the last sharpening, thereby preserving the cutting sharpness of the utensil for a longer time. If many utensils are immersed in the same container of emulsion of the invention, they must be arranged so that they do not have contact with each other. This cycle of immersing the utensil in the emulsion, using the utensil for its intended purpose and immersing the utensil in the emulsion during its non-use, allows for a considerable prolonging of the life of the utensil.

The greatest efficacy of the solution depends on the metal type and the hardening of the utensil. Additionally, the regular mechanical sharpening must be properly carried out, preferably with the use a double-faced grindstone, one side having grana 100 and the other side having grana 280. An optimum angle for utensils such as knives and cutlery is generally 20 to 28 degrees. Thus, a 10-14° angle must be provided on each side of the edge when positioning the tool steel on the stone. Then, the stone is changed to the fine side (grana 280) and the sliding movements are alternated again. The cutting edge may be examined to determine that the knife already shows a very good edge. At this instance, a stone with a finer grana can be used (approximately 400 or 500). Alternatively, a piece of crocus cloth with 400 or 500 grana is placed on a piece of wood used it as a regular stone. Other stones may be used for sharpening procedures, such as Arkansas stones and diamond sharpeners, both of which can achieve an excellent sharpening.

The emulsion is effective in preserving the cutting edge of a utensil. However, the efficacy of the emulsion depends on several factors including, but not limited to, the metal type, the cutting edge thickness and the hardening of the utensil. In addition, the level of preservation of the cutting edge and its duration is also dependent upon the effectiveness of the emulsion in exploiting the metals' martensitic properties, in protecting the chromic oxide protective film and in avoiding formation of iron oxide (rust) on the cutting edge. Accordingly, the emulsion is more effective for certain metals and for certain types of utensils.

For example, in utensils made of iron, steel or other iron based materials, there is a strong natural trend to form iron oxide (rust). Furthermore, these iron products are not provided with a protective film against oxidation. The martensitic property is also limited to the thermal pre-treatment undergone by some iron utensils (hardening and case hardening). Additionally, most iron objects are only cast, and therefore are most likely to lose the cutting sharpness at a faster rate. Accordingly, the emulsion was effective in minimizing the formation of iron oxide and thereby preserving the sharpness of the cutting edge. Since the iron, steel and other iron by-products have shown a limited martensitic effect and do not have a protective film on the cutting edge surface, there are less properties for the emulsion to exploit. Thus, the sharpness of an iron or steel utensil is preserved for a shorter period of time when compared to other metals such as stainless steel.

For utensils fabricated from metals such as stainless steel, the preservation effect is more effective in that in lasts for a longer period of time. For stainless steel utensils, the cutting sharpness preservation lasted between ten days to several weeks. The emulsion of the present invention is more effective on metals having similar properties as stainless steel since it can exploit several properties. For example, the emulsion is effective in exploiting the metals' martensitic properties, in protecting the chromic oxide protective film as well as avoiding the formation of iron oxide (rust) on the cutting edge.

As embodied herein, and in accordance with one aspect of the invention, a direct relationship exists between the cutting edge thickness of the stainless steel cutlery utensils and the preservation level of the cutting sharpness achieved by the emulsion. Specifically, the smaller the cutting edge thickness, the greater the preservation level of the cutting sharpness. Accordingly, utensils having small cutting edge thicknesses, such as surgical instruments, benefit most from the emulsion of the invention.

The emulsion of the present invention improves the chemical, mechanical and physical interaction of the cutting edge surface of the utensil and is effective in preserving the sharpness of the cutting edge of utensils, such as for example, iron cutlery and stainless steel cutlery. For iron cutlery, the cutting sharpness preservation lasted approximately 5 days. Longer preservation periods, however, were demonstrated for stainless steel cutlery Therefore, the use of the emulsion of the invention is effective in extending the sharpness of the cutting edge of a utensil and is beneficial for both the iron cutlery, with an effectiveness term of five days, and for the stainless steel cutlery, with an effectiveness term of several weeks.

### EXAMPLES

The following examples as set forth herein are meant to illustrate and exemplify the present invention and are not intended to limit the invention in any way.

### EXAMPLE 1

### Tests On Iron Cutlery

The effectiveness of the emulsion in preserving the sharpness of the cutting-edge for four different types of iron cutlery was evaluated. Specifically, four different formulations were evaluated and the ideal concentration of mineral oil was tested.

To determine the effects of the emulsion on tool steels, and to determine the amount of preservation of the cutting edge sharpness of the cutlery utensils, the sharpening thickness of the cutting edge was measured by means of high resolution optical microscopy. The cutting edge wear of the cutlery utensil (percent unsharpening factor) was calculated according to the following mathematical ratio:

Ft D %=(EFf/EFi)×100% (Formula 1)

where:

Ft D %=Percent unsharpening factor

EFf=Thickness of the tool steels final cutting edge (after being used)

EFi=Thickness of the tool steels initial cutting edge (without being used)

Measurements were taken three tines a day for 10 days and an average percent unsharpening factor was calculated. The friction tests were simulated in the laboratory with a wear ratio similar to that of normal use of the different metal utensils.

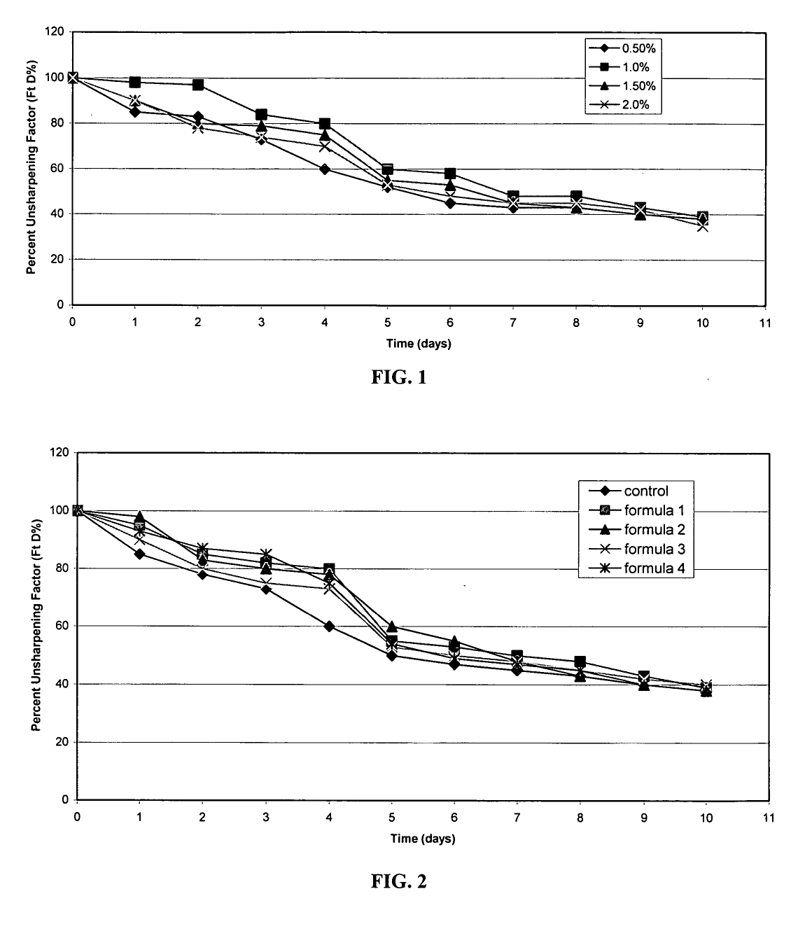

The effect of mineral oil on the effectiveness of the formulation in preserving sharpening level was evaluated. Mineral oil inhibits the formation of iron oxide in those utensils manufactured from iron. Mineral oil was added to the formulation in vary concentrations to determine which concentration was most effective in maintaining homogeneity and effectiveness. The mineral oil concentration was 0.5, 1, 1.5 and 2 weight percent of the emulsion. As illustrated in FIG. 1, for a mineral oil concentration varying from 0.5-2%, a concentration of 1% was the most effective in minimizing cutting edge wear.

The effect of four different emulsion formulations in preserving the cutting edge of iron utensils was determined. Formulations 1-4, as outlined supra, were used. The control was an iron utensil not submerged in an emulsion. FIG. 2 illustrates that the emulsions were successful in preserving the cutting edge of the iron utensils. However, from the fifth day on, a spot overlaying trend was observed, that is, the percent unsharpening factor was almost identical to the control. Accordingly, the emulsions were effective in preserving iron cutlery sharpness for approximately 5 days only.

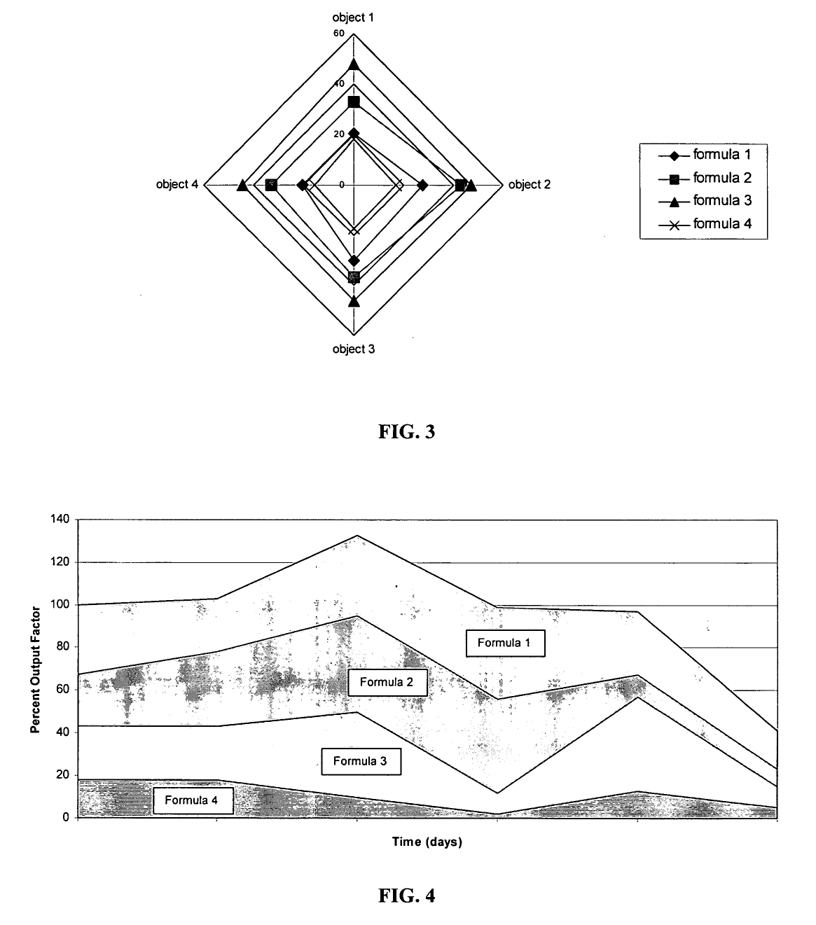

In addition, the effectiveness of formulas 1-4 was evaluated. FIG. 3 illustrates that from a mathematical point of view, formulas 3 and 4 were efficient have a greater efficiency in preserving the cutting sharpness of the iron utensil. However, FIG. 4 illustrates that the utilization performance of the more viscous emulsion of formulations 1 and 2 was in fact higher.

### EXAMPLE 2

### Test On Stainless Steel Cutlery

The effectiveness of the emulsion in preserving cutting sharpness for four different types of stainless steel cutlery was evaluated. Specifically, four different formulations were evaluated.

As discussed above in Example 1, to determine the effects of the emulsion on the stainless steel utensils, and to determine the amount of preservation of the cutting edge sharpness of the cutlery utensils, the sharpening thickness of the cutting edge was measured by means of high resolution optical microscopy. The cutting edge wear of the cutlery utensil (percent unsharpening factor) was calculated according to Formula 1.

Measurements were taken three tines a day for 10 days and an average percent unsharpening factor was calculated. The friction tests were simulated in the laboratory with a wear ratio similar to that of normal use of the different metal utensils.

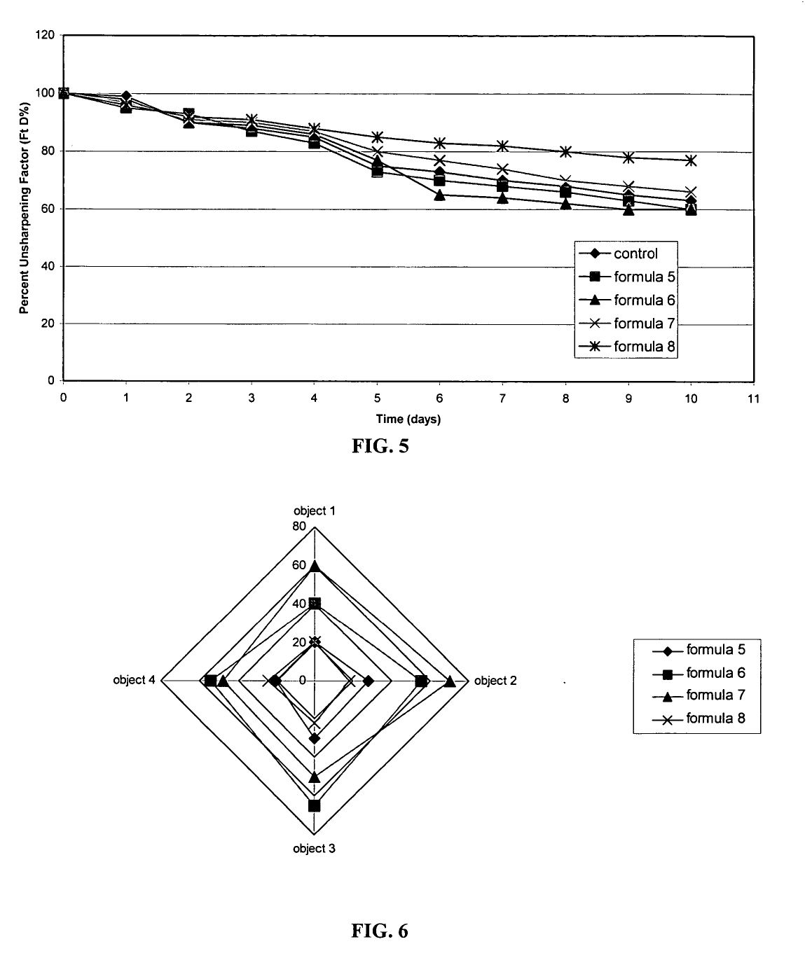

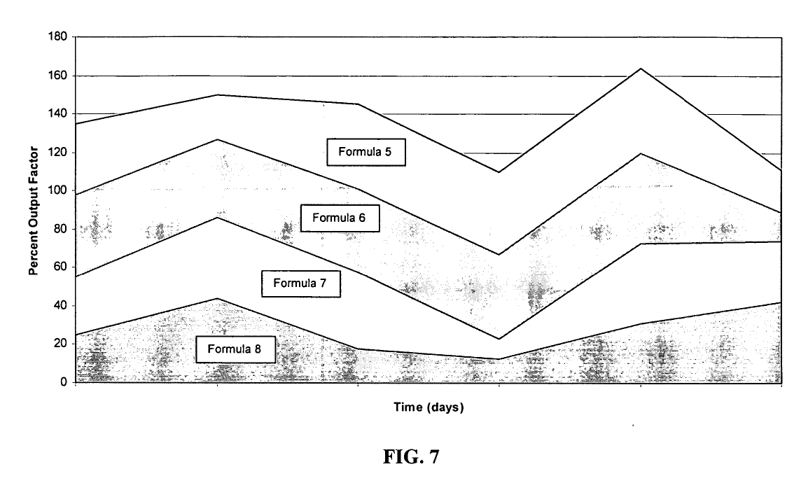

The effect of four different emulsion formulations in preserving the cutting edge of stainless steel utensils was determined. Formulations 5-8, as detailed supra, were used. The control was an stainless steel utensil not submerged in an emulsion. FIG. 5 illustrates that the emulsions with formulas 5-8 were very effective in preserving the cutting edge of the stainless steel utensils. In fact, a comparison of FIGS. 2 and 5 illustrates that the emulsion was more effective in preserving the cutting edge of the stainless steel utensils than the iron utensils. In comparing FIGS. 2 and 5, specifically in analyzing the end of the curves, it is evident that in FIG. 2 the curves are decreasing and nearly coincident while in FIG. 5 the curves are parallel, horizontal and non-coincident. Extrapolation of FIG. 5 illustrates that the emulsion is effective in preserving the cutting edge of the stainless steel utensils for several weeks.

The effectiveness of formulas 5-8 was further evaluated. FIG. 6 illustrates that from a mathematical point of view, formulas 7 and 8 were more efficient than formulas 5 and 6 in preserving the cutting sharpness of the stainless steel utensil. However, similar to what was found for iron cutlery, FIG. 4 illustrates that the more viscous emulsion of formulations 5 and 6 are more effective in providing a higher utilization performance.

It will be apparent to those skilled in the art that various modifications and variations can be made in the method and system of the present invention without departing from the spirit or scope of the invention. Thus, it is intended that the present invention include modifications and variations that are within the scope of the appended claims and their equivalents.

What is claimed is:

1. An emulsion for preservation of a metal utensil having a cutting edge during periods of non-use, the emulsion comprising
at least one of a water-soluble salt of an ether compound or a chloride compound in an amount sufficient to preserve the cutting edge of the utensil;
a hydrophobic substance in an amount sufficient to reduce water contact with the tool steel's edge; and
an alcohol in an amount sufficient to assist in solubilizing the hydrophobic substance,
wherein immersion of the cutting edge of the utensil in the emulsion preserves the sharpness of the cutting edge to facilitate longer service of utensil.

2. The emulsion of claim 1, wherein the soluble salt of an ether compound is sodium sulphate lauryl ether.

3. The emulsion of claim 1, wherein the chloride compound is cetyltrimethyl ammonium chloride.

4. The emulsion of claim 1, wherein the hydrophobic substance is selected from the group consisting of: soap base, anhydrous lanolin, and liquid glycerin, or any combination thereof.

5. The emulsion of claim I, wherein the alcohol is selected from the group consisting of: triethanolamine, and ketostearylic alcohol, or a combination thereof.

6. The emulsion of claim 1, wherein the metal utensil is selected from the group consisting of, tool steels, knives, cutlery, blades, scalpels, scissors, clippers, cutters, manicure tools, and surgical tools.

7. The emulsion of claim 6, wherein the metal utensil is fabricated from a material selected from the group consisting of stainless steel, iron, steel and alloys thereof.

8. The emulsion of claim 7 further including a reagent for reducing the deposition of iron oxide on the utensil.

9. The emulsion of claim 8, wherein the reagent is a lubricant.

10. The emulsion of claim 8, wherein the reagent is present in an amount from about 0.5 to about 2 weight percent of the emulsion.

11. The emulsion of claim 1, wherein the metal utensil is made of a metal having shape memory properties and immersion of the cutting edge of the utensil in the emulsion is sufficient to allow the metal to recover a previous molecular arrangement of its shape memory properties.

12. The emulsion of claim 1, wherein immersion of the cutting edge of the utensil in the emulsion is sufficient to maintain a chromic oxide protective film on the cutting edge.

13. The emulsion of claim 1, wherein immersion of the cutting edge of the utensil in the emulsion is sufficient to prevent formation of iron oxide on the surface of the cutting edge.

14. An emulsion for preserving the cutting edge of a utensil, the emulsion comprising: soap base, sodium sulphate lauryl ether, ketostearylic alcohol, cetyltrimethyl ammonium chloride, anhydrous lanolin, liquid glycerin, and triethanolamine in combined amounts effective to preserve the edge of the utensil when immersed therein.

15. The emulsion of claim 14, wherein the soap base is present in an amount between about 5-15%, sodium sulphate lauryl ether is present in an amount between about 3 to 7%; the ketostearylic alcohol is present in an amount between about 2 to 4%; the cetyltrimethyl ammonium chlorate is present in an amount between about 2 to 4%; the anhydrous lanolin is present in an amount between about 3 to 7%; the glycerin is present in an amount between about 3 to 7%; triethanolamine is present in an amount between about 0.5 to 1.5.

16. The emulsion of claim 15, which further comprises an additive selected from the group consisting of: aloe vera glycolic extract; propolis glycolic extract; propylene glycol; methyl parabene; hydrolyzed wheat oil; hydrolyzed soya oil; fragrance; mineral oil and coloring agent, or any combination thereof.

17. The emulsion of claim 16, wherein the aloe vera glycolic extract is present in a proportion between about 1 to 3%; the propolis glycolic extract is present in a proportion of between about 1 to 3%; the propylene glycol is present in a proportion of between about 0.3 to 0.7%; the methyl parabene is present in a proportion between about 0.1 to 0.3%; the hydrolyzed wheat oil is present in a proportion of between about 0.3 to 0.7%; the hydrolyzed soya oil is present in a proportion of between about 0.3 and 0.7%; the fragrance is present in a proportion of between about 0.3 and 0.7%; the coloring agent is present in a proportion of about 0.01%.

18. The emulsion of claim 16, comprising sodium sulphate lauryl ether, liquid glycerin, triethanolamine, aloe vera glycolic extract; propolis glycolic extract; fragrance; propylene glycol; methyl parabene; coloring agent; and water.

19. The emulsion of claim 16, wherein the glycerin is present in a proportion of about 3 to 7%, the aloe vera glycolic extract is present in a proportion of about 1 to 3%, the propolis glycolic extract is present in a proportion of about 1 to 3%, the fragrance is present in a proportion of about 0.3 to 0.7%, the triethanolamine is present in a proportion of about 1 and 3%, the propylene glycol is present in a proportion of about 0.3 to 0.7%, the methyl parabene is present in a proportion of about 0.1 to 0.3%, the propyl parabene is present in a proportion of about 0.1 to 0.3%, the color is present in a proportion of about 0.01%.

20. The emulsion of claim 16, wherein the sodium sulphate lauryl ether is present in an amount of about 15 to 25%.

21. The emulsion of claim 15, wherein the cetyltrimethyl ammonium chlorateis present in an amount of about 15 to 25%

22. A method for preserving the cutting edge of a utensil, the method comprising the steps of:
preparing an emulsion that includes at least one of a water-soluble salt of an ether compound or a chloride compound in an amount sufficient to maintain oxide portions of the cutting edge, a hydrophobic substance in an amount sufficient to reduce water contact with the cutting edge of the utensil; and an alcohol in an amount sufficient to assist in solubilizing the hydrophobic substance, and
immersing the cutting edge of the utensil in the emulsion to preserve the sharpness of the cutting edge to facilitate longer service of utensil.

23. The method of claim 22, further comprising mixing and homogenizing the edge preservation compound, the hydrophobic substance, and alcohol to form an emulsion; and allowing the homogenized emulsion to stand for about 24 to 32 hours prior to immersion of the edge into the emulsion.

24. The method of claim 22, wherein the water-soluble salt of an ether compound is sodium sulphate lauryl ether.

25. The method of claim 22, wherein the chloride compound is cetyltrimethyl ammonium chloride.

26. The method of claim 22, wherein the hydrophobic substance is selected from the group consisting of: soap base, anhydrous lanolin, liquid glycerin, and any combination thereof.

27. The method of claim 22, wherein the alcohol is selected from the group consisting of: triethanolamine, ketostearylic alcohol, and a combination thereof.

28. The method of claim 22, wherein the emulsion further comprises a component selected from the group consisting of aloe vera glycolic extract; propolis glycolic extract; propylene glycol; methyl parabene; hydrolyzed wheat oil; hydrolyzed soya oil; fragrance; coloring agent, and any combination thereof.

29. The method of claim 22, wherein the emulsion further includes a reagent for reducing the deposition of oxide on the metal.

30. The method of claim 29, wherein the reagent is a lubricant.

31. The method of claim 29 wherein the reagent is present in an amount between about 0.5% to 2.0% of the weight of the emulsion.
